(19) United States
(12) Patent Application Publication
(10) Pub. No.: US 2025/0015952 A1
(43) Pub. Date: Jan. 9, 2025

(54) TERMINAL, RADIO COMMUNICATION METHOD, AND BASE STATION

(71) Applicant: NTT DOCOMO, INC., Tokyo (JP)

(72) Inventors: Naoya Shibaike, Tokyo (JP); Yuki Matsumura, Tokyo (JP); Satoshi Nagata, Tokyo (JP)

(73) Assignee: NTT DOCOMO, INC., Tokyo (JP)

(21) Appl. No.: 18/706,644

(22) PCT Filed: Nov. 5, 2021
(86) PCT No.: PCT/JP2021/040856

§ 371 Date: May 1, 2024

(51) Int. Cl. H04L 5/00

(52) U.S. Cl. CPC H04L 5/0051

(57) ABSTRACT

A terminal according to one aspect of the present disclosure includes: a control section that performs, for transmission of a reference signal for measurement (Sounding Reference Signal (SRS)) of an SRS resource of at least one of a plurality of SRS resources, control of whether to perform transmission or transmission in a different SRS resource, when a time difference between the plurality of SRS resources is smaller than a given value; and a transmitting section that transmits the SRS, based on a result of the control. According to one aspect of the present disclosure, it is possible to appropriately perform SRS transmission.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Rel-15 NR has various usages of a reference signal for measurement (Sounding Reference Signal (SRS)). For future radio communication systems (for example, Rel. 17), enhancement of SRS is studied.

When enhancement of SRS is employed, a case where overlap of SRS resources or the like occurs is considered. However, existing Rel-15/16 NR standards cannot deal with such a case. In this case, appropriate SRS transmission fails, and system throughput may decrease.

Thus, an object of the present disclosure is to provide a terminal, a radio communication method, and a base station that can appropriately perform SRS transmission.

### Solution to Problem

A terminal according to one aspect of the present disclosure includes: a control section that performs, for transmission of a reference signal for measurement (Sounding Reference Signal (SRS)) of an SRS resource of at least one of a plurality of SRS resources, control of whether to perform transmission or transmission in a different SRS resource, when a time difference between the plurality of SRS resources is smaller than a given value; and a transmitting section that transmits the SRS, based on a result of the control.

### Advantageous Effects of Invention

According to one aspect of the present disclosure, it is possible to appropriately perform SRS transmission.

### BRIEF DESCRIPTION OF DRAWINGS

FIG. 1 is a diagram to show an example of a guard period between SRS resources in different slots.

FIG. 2 is a diagram to show an example of a slot available for an A-SRS.

FIG. 3 is a diagram to show an example of frequency resources of an SRS for RPFS.

FIGS. 4A and 4B are each a diagram to show an example of a range(s) to which no-transmission operation is applied in a first embodiment.

FIG. 5 is a diagram to show an example of a schematic structure of a radio communication system according to one embodiment.

FIG. 6 is a diagram to show an example of a structure of a base station according to one embodiment.

FIG. 7 is a diagram to show an example of a structure of a user terminal according to one embodiment.

FIG. 8 is a diagram to show an example of a hardware structure of the base station and the user terminal according to one embodiment.

FIG. 9 is a diagram to show an example of a vehicle according to one embodiment.

### DESCRIPTION OF EMBODIMENTS

### (SRS)

Rel-15 NR has various usages of a reference signal for measurement (Sounding Reference Signal (SRS)). An SRS in NR is used not only for uplink (UL) CSI measurement also used in existing LTE (LTE Rel. 8 to Rel. 14) but also downlink (DL) CSI measurement, beam management, and the like.

A terminal (user terminal, User Equipment (UE)) may be configured with one or a plurality of SRS resources. Each SRS resource may be specified by an SRS resource index (SRI).

Each SRS resource may have one or a plurality of SRS ports (may correspond to one or a plurality of SRS ports). For example, the number of ports for each SRS may be one, two, four, or the like.

The UE may be configured with one or a plurality of SRS resource sets. One SRS resource set may be related to a given number of SRS resources. The UE may use a higher layer parameter commonly for SRS resources included in one SRS resource set. Note that a resource set in the present disclosure may be interpreted as a set, a resource group, a group, and the like.

Information related to an SRS resource or a resource set may be configured for the UE by using higher layer signaling or physical layer signaling (for example, downlink control information (DCI)) or a combination of these.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

SRS configuration information (for example, an RRC information element “SRS-Config”) may include SRS resource set configuration information, SRS resource configuration information, and the like.

SRS resource set configuration information (for example, an RRC parameter “SRS-ResourceSet”) may include an SRS resource set ID (Identifier) (SRS-ResourceSetId), a list of SRS resource IDs (SRS-ResourceId) used in the resource set, an SRS resource type, information of SRS usage, and the like. Note that each SRS resource ID may be referred to as an SRS Resource ID (SRI).

Here, the SRS resource type may indicate any one of periodic SRS (P-SRS), a semi-persistent SRS (SP-SRS), and an aperiodic SRS (A-SRS). Note that the UE may transmit a P-SRS and an SP-SRS periodically (or periodically after activation). The UE may transmit an A-SRS, based on an SRS request of DCI.

The SRS usage (RRC parameter “usage”) may be, for example, beam management (beamManagement), codebook, non-codebook (nonCodebook), antenna switching (antennaSwitching), and the like. For example, an SRS with codebook or non-codebook usage may be used for determination of a precoder for codebook based or non-codebook based uplink shared channel (Physical Uplink Shared Channel (PUSCH)) transmission based on an SRI.

For an SRS with beam management usage, it may be assumed that only one SRS resource per SRS resource set can perform transmission at a given time instant. Note that, when a plurality of SRS resources belong to respective different SRS resource sets, these SRS resources may be transmitted simultaneously.

The SRS resource configuration information (for example, an RRC parameter “SRS-Resource”) may include information related to an SRS resource ID (SRS-ResourceId), the number of SRS ports, SRS port numbers, transmission comb, SRS resource mapping (for example, time and/or frequency resource location, a resource offset, resource periodicity, the number of repetitions, the number of SRS symbols, an SRS bandwidth, and the like), hopping, an SRS resource type, a sequence ID, a spatial relation, and the like.

The UE may transmit an SRS in adjacent symbols corresponding to the number of SRS symbols among the last six symbols in one slot. Note that the number of SRS symbols may be one, two, four, or the like. The UE may initiate SRS transmission from the symbol that is an offset before the last symbol in one slot. The offset may be zero or more and five or less symbols given by an RRC parameter “startPosition.”

Note that the number of repetitions (RRC parameter “repetitionFactor”) may be a value equal to or smaller than the number of SRS symbols. When the number of repetitions is two or more, an SRS of the number of SRS symbols may be repeatedly transmitted over a plurality of slots.

The UE may switch a BWP (Bandwidth Part) in which an SRS is transmitted or switch an antenna, for each slot. The UE may apply at least one of intra-slot hopping and inter-slot hopping to SRS transmission.

### (SRS Antenna Switching)

In Rel-15 NR, antenna switching (which may also be referred to as antenna port switching) may be configurable as SRS usage as described above. SRS antenna switching may be used when downlink CSI acquisition is performed by using an uplink SRS in a time division duplex (TDD) band, for example.

For example, for a UE having capability that the number of antenna ports available for transmission is smaller than the number of antenna ports usable for reception, UL SRS measurement may be used for determination of a DL precoder.

Note that the UE may report UE capability information indicating a supported SRS transmission port switching pattern (for example, an RRC parameter “supportedSRS-TxPortSwitch”) to a network. This pattern may be expressed in the form of “txry” such as “t1r2” or “t2r4,” for example, and may mean that SRS transmission is possible by using x antenna ports of y antennas in total (which may be expressed as xTyR). Here, y may correspond to all or a subset of receive antennas of the UE.

For example, the UE of 2T4R (two transmission ports, four reception ports) may be configured with an SRS resource set including two SRS resources each having two ports and also having usage of antenna switching, for DL CSI acquisition.

Note that when x and y in “txty” are the same value, this may be expressed as xT=xR (for example, 4T=4R).

The UE may assume that the start symbols of the respective SRS resources in an SRS resource set with the usage of antenna switching are different from each other. The UE may assume that a guard period is present between SRS resources in one SRS resource set.

The guard period may be referred to as a no-transmission period, an SRS switching period, a port switching period, and the like. The UE may assume not to transmit a given signal (for example, a given other signal) in a guard period in a slot in which a PUSCH is transmitted.

The UE may use a guard period to turn on (which may be referred to as enable, activate, and the like) an antenna port to use for the next SRS transmission.

The length of the guard period between SRS resources may be equal to or longer than a minimum guard period Y between SRS resources shown in 3GPP TS 38.214 Table 6.2.1.2-1 (Y=one or two symbols). For example, it may be Y=1 (case where subcarrier spacing (SCS)=15, 30, or 60 kHz) and Y=2 (case where SCS=120 kHz), or the like.

The UE of Rel-15/16 NR expects that the same number of SRS ports is configured for all the SRS resources in an SRS resource set with the usage of antenna switching.

A UE of Rel-15/16 NR that has reported capability of 1T1R, 2T4R, or 1T4R does not expect that more than one SRS resource set is configured or triggered in one slot.

A UE of Rel-15/16 NR that has reported capability of 1T=1R, 2T=2R, or 4T=4R does not expect that more than one SRS resource set is configured or triggered in one symbol.

### (Enhancement of SRS)

For future radio communication systems (for example, Rel. 17), enhancement of SRS is studied. For example, SRS switching for up to eight antennas (for example, xTyR, x={1, 2, 4} and y={6, 8}) is studied.

For future radio communication systems, it is studied to enhance the number of symbols configurable for SRS transmission for improvement of coverage/capacity. For example, it is studied that the number of SRS symbols, the number of repetitions, and the like can take a value of eight, ten, 12, 14, or the like at maximum.

In this case, symbols in the first half of a slot can also be used for SRS transmission. To address such a case, it is studied that Y symbols corresponding to a guard period necessary for antenna switching are also considered (present) between SRS resources configured in different SRS resource sets. The UE may use a plurality of SRS resource sets with the usage of antenna switching to perform SRS transmission for DL CSI acquisition.

For example, when the UE can transmit (support) an SRS in all the symbols in each one slot for two SRS resource sets for antenna switching with xTyR located in two consecutive slots, for example, it is preferable that the minimum gap period (guard period) of Y symbols be present between the last OFDM symbol in a part of the first slot occupied by the SRS resource set and the first OFDM symbol of a part of the second slot occupied by the SRS resource set.

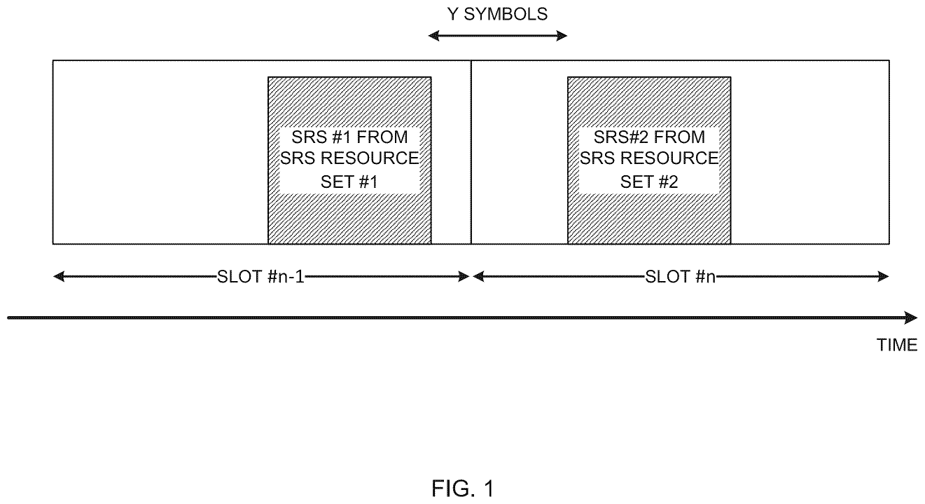

FIG. 1 is a diagram to show an example of a guard period between SRS resources in different slots. In this example, the UE is configured with transmission of SRS #1 included in SRS resource set #1 in slot #n−1 and transmission of SRS #2 included in SRS resource set #2 in slot #n. The minimum gap period (guard period) of Y symbols is present between SRS #1 and SRS #2.

For future radio communication systems, enhancement of A-SRS triggering is studied for flexible triggering/DCI overhead reduction. A Rel-15/16 A-SRS is transmitted in a slot that is a slot a slot offset after a slot in which triggering DCI is transmitted, the slot offset being configured by higher layer signaling (higher layer parameter “slotOffset”). In other words, in Rel. 15/16, a slot in which an A-SRS is desired to be transmitted restricts a transmission slot for triggering DCI.

In view of this, it is studied to allow a Rel-17 A-SRS to be transmitted in the (t+1)-th available slot counted from a reference slot. The reference slot may be a slot with triggering DCI or may be a Rel-15/16 A-SRS transmission slot (slot that is a slot a slot offset after the slot in which the triggering DCI is transmitted, the slot offset being configured by higher layer signaling).

An available slot is a slot in which a UL or flexible symbol is present corresponding to a time-domain location for all the SRS resources in a given resource set and may be a slot satisfying UE capability related to a requirement for minimum timing between a triggering PDCCH (DCI) and each of all the SRS resources in the resource set.

The value of t above may be specified by DCI, may be configured by RRC, or may be implicitly specified (for example, based on another parameter). Candidate values (possible values) for t may include 0. t may correspond to information indicating in which available slot SRS transmission is to be performed.

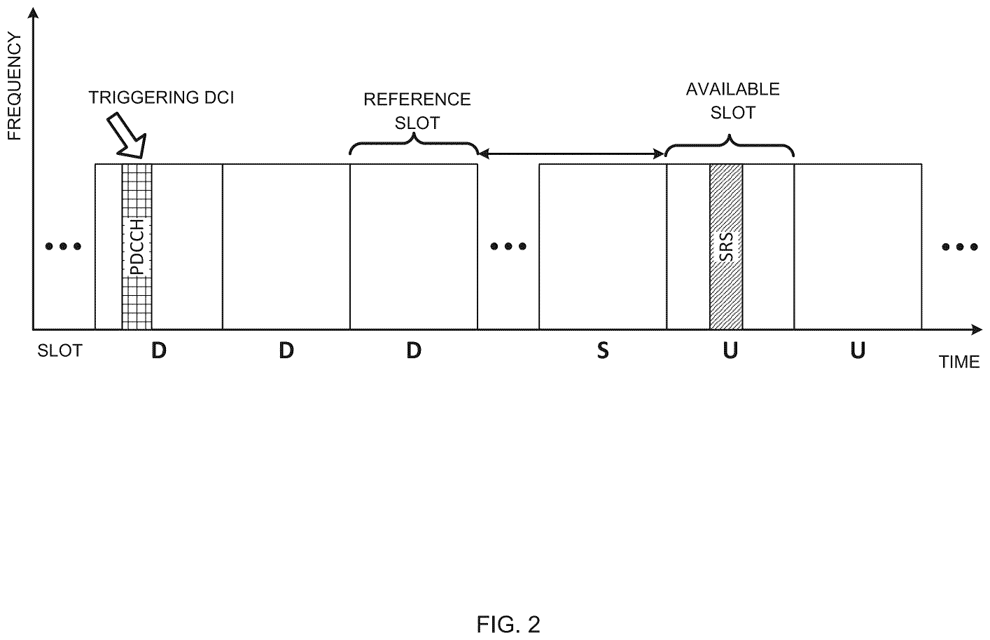

FIG. 2 is a diagram to show an example of a slot available for an A-SRS. In this example, six slots are shown, and the first three slots are DL slots while the next three slots are a special slot (which may be referred to as a flexible slot, a slot including a flexible symbol, and the like and may include at least one of DL, UL, and a guard period), and two UL slots. A DL slot, a flexible slot, a UL slot, or the like may be specified by the configuration of a TDD UL/DL configuration of which the UE is notified by higher layer signaling.

In this example, the UE receives triggering DCI for an A-SRS in a PDCCH in the first DL slot. In this example, it is assumed that the reference slot is a Rel-15/16 A-SRS transmission slot and a slot offset configured by higher layer parameter “slotOffset” is two. In this case, the third DL slot is a reference slot.

In this example, the (t+1)-th available slot counted from the reference slot is assumed to be the first UL slot shown in FIG. 2. The UE may transmit a triggered A-SRS in the available slot.

In Rel. 15/16, triggering DCI cannot be transmitted in the first DL slot since the A-SRS transmission slot is a DL slot. However, in the example in FIG. 2, flexible scheduling is possible since the actual A-SRS transmission slot is an available slot including a UL symbol.

When such enhancement of SRS is employed, a case where overlap of SRS resources and the like occur is considered. However, existing Rel-15/16 NR standards cannot deal with such a case. In this case, appropriate SRS transmission fails, and system throughput may decrease.

Thus, the inventors of the present invention came up with the idea of a control method in which a UE appropriately transmits at least one of a plurality of SRS resources having an insufficient guard period or overlap.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, “activate,” “deactivate,” “indicate,” “select,” “configure,” “update,” “determine,” and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC CE), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station (BS), spatial relation information (SRI), a spatial relation, a reference signal for measurement (Sounding Reference Signal (SRS)) resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, “drop,” “suspend,” “cancel,” “puncture,” “rate-match,” “postpone,” “not transmit,” and the like may be interchangeably interpreted.

In the present disclosure, an SRS, an SRS resource, and SRS transmission may be interchangeably interpreted.

### (Radio Communication Method)

In the following embodiments, control of SRS transmission in at least one of the following cases will be described:
case 1: case where a Y-symbol guard period cannot be guaranteed between a plurality of SRS resources configured for the same/different SRS resources with the usage of antenna switching (specifically, the time offset between these SRS resources is less than Y symbols, or these SRS resources overlap) and
case 2: case where a plurality of SRS resources configured for the same/different SRS resource sets overlap.

Note that, in the present disclosure, a time offset, a time difference, an offset, a distance, and the like may be interchangeably interpreted.

Note that case 2 may correspond to a case that occurs due to at least one of eight, ten, 12, and 14 is configured as the number of symbols of the overlapping SRS resources, may correspond to a case that occurs due to an A-SRS resource/resource set triggered by triggering DCI is transmitted in an available slot counted from a reference slot, or may correspond to a case other than these.

In the following embodiments, an “above case” may be interpreted as case 1/2 or may be interpreted as a case where the time difference of a plurality of SRS resources is smaller than a given value (for example, Y symbols, 0 symbols), which is a superordinate concept of case 1/2. A plurality of SRS resources overlapping may be interpreted as the time difference between these is smaller than 0 symbols.

In the following embodiments, the UE may control whether transmission is possible (whether to perform transmission) or transmission in a different SRS resource, for transmission of at least one SRS resource of a plurality of SRS resources in the above case.

### First Embodiment

In a first embodiment, the UE does not actually transmit (cancels/drops) at least one or both of SRS resources in a plurality of SRS resources in the above case.

### {Determination of SRS Resource not to Transmit}

The UE may determine an SRS resource not to transmit, based on any one or a combination of the following:
(1) resource type configured for an SRS resource set related to the SRS resource (including the SRS resource),
(2) SRS resource ID of the SRS resource (srs-ResourceId),
(3) SRS resource set ID (srs-ResourceSetId) of the SRS resource set related to the SRS resource,
(4) symbols of the SRS resource,
(5) the number of repetition transmissions of the SRS resource,
(6) comb configuration (the number of combs/comb offset) of the SRS resource,
(7) configuration (for example, the transmission configuration, the transmission band configuration) related to the SRS resource,
(8) usage of the SRS resource set related to the SRS resource, and
(9) transmission periodicity/transmission offset of the SRS resource.

In other words, the UE may determine an SRS resource that satisfies a condition based on any one or a combination of (1) to (9) above, not to transmit.

For (1) above, priorities may be defined in such an order as aperiodic>semi-persistent>periodic for resource type (in this case, aperiodic has the highest priority). The UE need not transmit an SRS with a low priority. Note that the order of priorities may be an order obtained by freely interchanging aperiodic, semi-persistent, and periodic, or a plurality of resource types may have the same priority.

For (2) above, the UE need not transmit an SRS resource related to a lower (or higher) SRS resource ID. Note that (2) above may be applied a case where the plurality of SRS resources are related to the same (single) SRS resource set or may be applied to a case where the plurality of SRS resource sets are related to respective different SRS resource sets.

For (3) above, the UE need not transmit an SRS resource related to a lower (or higher) SRS resource set ID. Note that (3) above may be applied a case where the plurality of SRS resources are related to respective different SRS resource sets.

For (4) above, the UE need not transmit an SRS resource having a configured first (or last) symbol being late (later/in the future) in terms of time. Note that, in the present disclosure, “late in terms of time/later/in the future” may be interchangeably interpreted as “early in terms of time/earlier/in the past.” Note that the configured first symbol may be judged by an RRC parameter “startPosition” related to the SRS resource.

Note that, in the present disclosure, a suffix indicating introduction in a specific resource (for example, “_r16,” “_r17,” “−r16,” “−r17,” or the like) may be added to each term of RRC information elements, RRC parameters, and the like. The suffix need not be added, or another word may be added.

For (5) above, the UE need not transmit an SRS resource having a larger (or smaller) configured number of repetitions (number of repetition transmissions). Note that the configured number of repetitions may be judged by an RRC parameter “repetitionFactor” related to the SRS resource.

For (6) above, the UE need not transmit an SRS resource having a smaller (or larger) configured number of combs/comb offset. Note that the configured comb configuration (number of combs/comb offset) may be judged by an RRC parameter “transmissionComb” related to the SRS resource.

For (7) above, the UE need not transmit an SRS resource for resource block level partial frequency measurement (RB-level Partial Frequency Sounding (RPFS)).

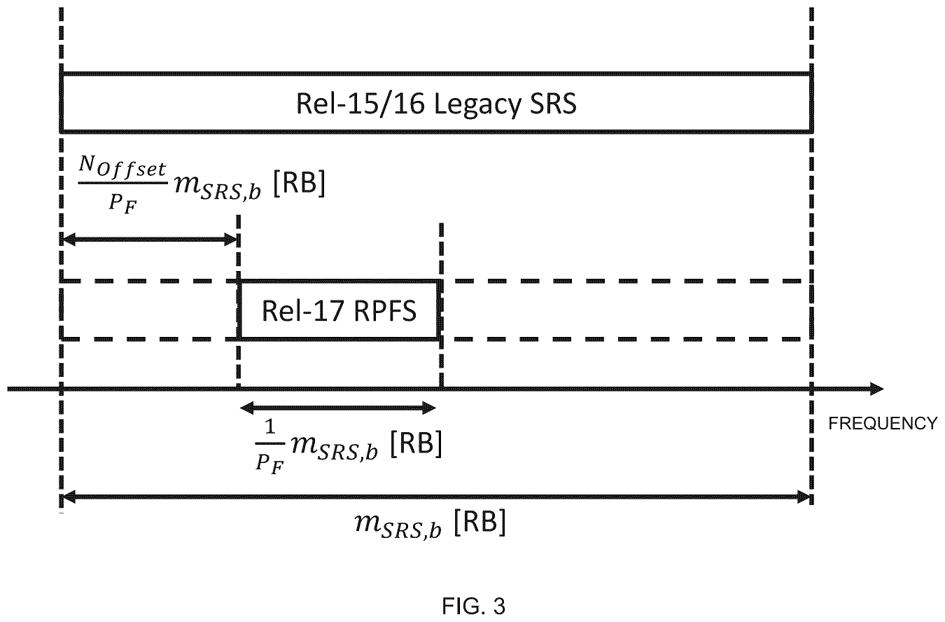

FIG. 3 is a diagram to show an example of frequency resources of an SRS for RPFS. An existing Rel-15/16 NR SRS (legacy SRS) is transmitted by using m_{SRS,b} resource blocks (RBs) derived by a higher layer parameter.

In contrast, an SRS for RPFS studied for Rel. 17 is transmitted within the bandwidth of the legacy SRS by using a bandwidth (m_{SRS,b}/P_{F}) smaller than that of the legacy SRS with application of an offset (N_{offset}M_{SRS,b}/P_{F}). Here, P_{F} and N_{offset} denote parameters for determining the frequency domain resource of the SRS for RPFS, and P_{F} is the denominator used for division for computing an RPFS SRS band based on the Rel-15/16 SRS while N_{offset} is an offset to the start RB of the RPFS SRS with respect to the start RB of the Rel-15/16 SRS.

Note that P_{F} and N_{offset} may be configured for the UE by using physical layer signaling (for example, DCI), higher layer signaling (for example, RRC signaling, MAC CE), or a specific signal/channel, or a combination of these, or may be determined based on UE capability.

For (7) above, the UE need not transmit an SRS resource with which a configuration related to P_{F}/N_{offset} is associated. The UE need not transmit an SRS resource having a larger (or smaller) value of associated P_{F}/N_{offset}.

For (8) above, priorities may be defined for usage in such an order as antenna switching>beam management>codebook>non-codebook (in this case, antenna switching has the highest priority). The UE need not transmit an SRS with a low priority. Note that the order of priorities may be an order obtained by freely interchanging antenna switching, beam management, codebook, and non-codebook, or a plurality of usages may have the same priority.

For (9) above, the UE need not transmit an SRS resource having smaller (or larger) configured transmission periodicity/transmission offset. Note that the configured transmission periodicity/transmission offset may be judged by an RRC parameter “SRS-PeriodicityAndOffset” related to the SRS resource.

Note that the above-described method of determining an SRS resource not to be transmitted may be used for determination of an SRS resource to transmit (it is only needed to interpret an “SRS resource not to be transmitted” as an “SRS resource to be transmitted”). In this case, an SRS resource that is not the SRS resource to transmit may be determined as an SRS resource not to transmit.

{Range(s) (Period(s)) to which No-Transmission Operation is Applied}

When an SRS resource determined not to be transmitted in the above case corresponds to a P-SRS/SP-SRS, the UE may apply no-transmission operation only to the SRS resource corresponding to the above case (in other words, may judge whether to perform transmission for each cycle of periodicity/transmission occasion) or to a plurality of SRS resources including the SRS resource corresponding to the above case. In the latter case, the plurality of SRS resources may include the SRS resource corresponding to the above case and a related SRS resource(s) subsequent to the SRS resource. Here, the related SRS resource(s) may be at least one of the same SRS resource as the SRS resource corresponding to the above case and one or more SRS resources in the SRS resource set including the SRS resource.

When the SRS resource determined not to be transmitted in the above case corresponds to an A-SRS, the UE may apply no-transmission operation only to the SRS resource corresponding to the above case.

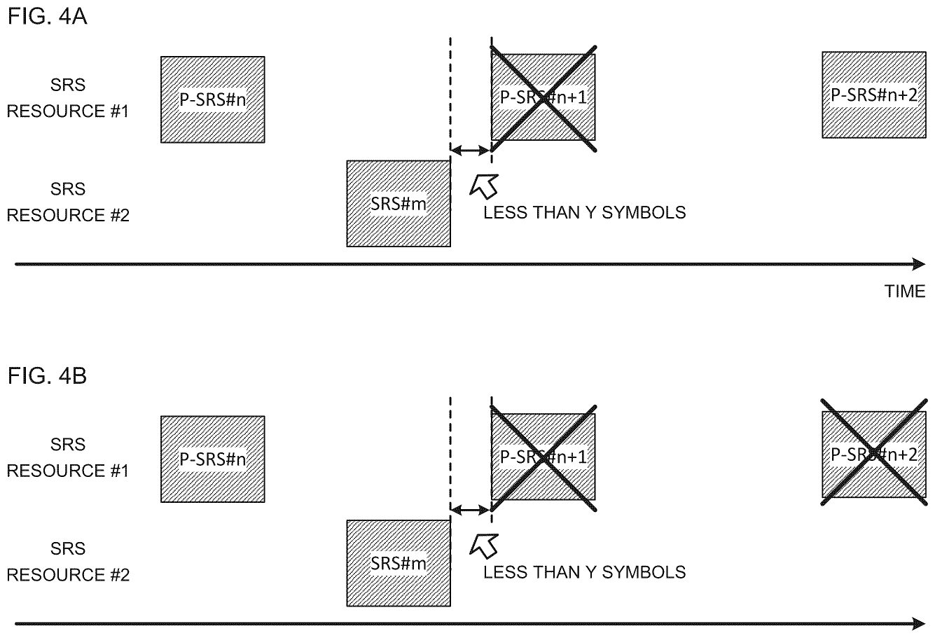

FIGS. 4A and 4B are each a diagram to show an example of a range(s) to which no-transmission operation is applied in the first embodiment. In this example, for SRS resource #1 being a P-SRS and SRS resource #2 being any SRS, an example that P-SRS #(n+1), which is (n+1)-th SRS resource #1, and SRS #m, which is m-th SRS resource #2, correspond to case 1 above is shown. The SRS resource determined not to be transmitted is P-SRS #(n+1).

FIG. 4A is an example of applying the no-transmission operation only to the SRS resource corresponding to the above case. In this case, P-SRS #(n+2), which is (n+2)-th SRS resource #1 not corresponding to the above case, may be transmitted.

FIG. 4A is an example of applying the no-transmission operation to the SRS resource corresponding to the above case and all the same SRS resources subsequent to the SRS resource. In this case, P-SRS #(n+2) is not transmitted.

Note that application of the no-transmission operation may be canceled after the elapse of a given time period. In other words, also in the example in FIG. 4B, it may be returned to enable transmission of a P-SRS in SRS resource #1 after the elapse of the given time period. The given time period may be defined in a specification in advance, may be configured for the UE by using physical layer signaling (for example, DCI), higher layer signaling (for example, RRC signaling, MAC CE), or a specific signal/channel or a combination of these, or may be determined based on UE capability.

Note that every time the above case occurs, a timer for measuring the given time period may be started/restarted. When the timer expires, the UE may stop application of the no-transmission operation.

Note that, when the no-transmission operation is applied to a P-SRS resource, the P-SRS resource may be judged (regarded) as being disabled. When the no-transmission operation is applied to an SP-SRS resource, the SP-SRS resource may be judged (regarded) as being deactivated.

Application of the no-transmission operation may be canceled by RRC reconfiguration or the like for a P-SRS resource or may be canceled by activation using a MAC CE or the like for an SP-SRS resource.

According to the first embodiment described above, the UE can appropriately transmit any of a plurality of SRS resources having an insufficient guard period or overlapping.

### Second Embodiment

In a second embodiment, the UE transmits one or both of SRS resources of a plurality of SRS resources in the above case, in a different resource that is different from a resource expected to be used for transmission (for example, a configured resource).

This “different resource” will also be referred to as a resource after change. Note that the UE transmits an SRS resource that is not the SRS resource to be transmitted in the resource after change among the plurality of SRS resources in the above case, in the resource originally expected to be used for transmission.

{Determination of SRS Resource to Transmit in Resource after Change}

For determination of an SRS resource to transmit in a resource after change, the above-described method of determining an SRS resource not to transmit in the first embodiment may be used (it is only needed to interpret an “SRS resource not to transmit” as an “SRS resource to transmit in a resource after change”).

Note that, for determination of an SRS resource to transmit in a resource after change, a condition that part or the entire of the resource after change is included in UL symbols/UL slot may be used instead of or in addition to the condition for the above-described method of determining an SRS resource not to transmit in the first embodiment (for example, when part of or the entire of the resource after change is included, the resource is determined as an SRS resource to transmit in the SRS resource after change).

{Determination of Resource after Change}

The UE may determine at least one of the following resources to be the above resource after change:
resource obtained by shifting a resource expected to be used for transmission to be earlier, when the resource expected to be used for transmission is early in terms of time (in the past) among the plurality of SRS resources in the above case, and
resource obtained by shifting a resource expected to be used for transmission, to be later, when the resource expected to be used for transmission is late in terms of time (in the future) among the plurality of SRS resources in the above case.

Note that the UE may determine the resource obtained by shifting the resource expected to be used for transmission to be earlier or later as the resource after change, until the time offset between the resource after change and another SRS resource reaches Y symbols or more. Here, such another SRS resource may be a resource not changed among the plurality of SRS resources in the above case or may be another resource after change (when both resources are changed) among the plurality of SRS resources in the above case.

The resource after change is preferably a UL symbol(s). The UE may determine the resource obtained by shifting the resource expected to be used for transmission to be earlier or later as the resource after change, until the time offset between the resource after change and another SRS resource reaches Y symbols or more and part or the entire of the resource after change becomes a UL symbol(s).

With such a configuration, a sufficient guard period can be ensured between SRS resources.

Note that the unit of a shift amount for a resource after change from a resource originally expected to be transmitted may be, for example, units of symbols, or may be units of slots. When the shift is made in units of symbols, the UE may change the value of startPosition (or interpret that the value is/has become a value different from a configured value). When the shift is made in units of slots, the UE may change the value of SRS-PeriodicityAndOffset (periodicityAndOffset-p/-sp) in a P-/SP-SRS and the value of slotOffset or the value of t indicating the above-described available slot in an AP-SRS (or interpret that the value is/has become a value different from a configure/specified value).

Information related to the shift amount for the time resource location of an SRS may be configured for the UE by using physical layer signaling (for example, DCI), higher layer signaling (for example, RRC signaling, MAC CE), or a specific signal/channel or a combination of these, or may be determined based on UE capability.

The information related to the shift amount for the time resource location of an SRS may include at least one of the following, for example:
periodicity/offset (when the SRS is a P-SRS/SP-SRS),
slot offset/symbol offset (when the SRS is an A-SRS),
SRS resource ID of an SRS resource to which shift is applied (to be a change target),
SRS resource set ID of an SRS resource set including an SRS resource to which shift is applied,
resource type/the number of repetition transmissions/comb configuration/related configuration (for example, the transmission configuration, the transmission band configuration) of an SRS resource to which shift is applied, and
usage of the SRS resource set including an SRS resource to which shift is applied.

Note that, when the information related to a shift amount of a time resource location of an SRS includes an SRS resource set ID, all the SRS resources in the SRS resource set corresponding to the SRS resource set ID may be shifted based on the information, or part of the SRS resources may be shifted based on the information.

For example, the UE may change (update) the value configured for SRS-PeriodicityAndOffset (periodicityAndOffset-p/-sp) in a P-/SP-SRS or slotOffset in an A-SRS, based on notification of a MAC CE including the information related to a shift amount of the time resource location of an SRS. When an SRS resource ID/SRS resource set ID is included in the MAC CE, the UE may determine an SRS resource/SRS resource set to which time-direction resource allocation change (shift) is applied, based on the SRS resource ID/SRS resource set ID.

The UE may be configured/activated with a set of candidate values for the shift amount by RRC/MAC CE. The UE may determine a shift amount to actually apply, from the configured/activated set of candidate values by notification of a MAC CE/DCI.

Note that the UE may handle the shift amount of the time resource location of an SRS, as an absolute value or may handle the shift amount as an accumulation value. In the former case, every time the UE receives information related to a shift amount of the time resource location of the SRS for a given SRS resource, the UE may judge the shift amount of the time resource location of the SRS, based on the newly received information. In the latter case, every time the UE receives information related to a shift amount of the time resource location of the SRS for a given SRS resource, the UE may judge the shift amount of the time resource location of the SRS, based on the current shift amount and the newly received information.

According to the second embodiment described above, the UE can appropriately transmit both of a plurality of SRS resources having an insufficient guard period or overlapping.

### Other Embodiments

At least one of the above-described embodiments may be applied only to a UE that has reported a specific UE capability or supports the specific UE capability.

The specific UE capability may indicate at least one of the following:
whether to support specific operation/information in each embodiment (for example, control of whether to perform SRS transmission in case 1/2 (first embodiment), control of shift of an SRS (second embodiment)) and
minimum guard period necessary between two SRS resources in an SRS resource set for antenna switching.

Note that the minimum guard period necessary between two SRS resources in an SRS resource set for antenna switching may include 0. When the UE capability related to the minimum guard period necessary between two SRS resources in an SRS resource set for antenna switching is not reported, the value Y may be assumed to be the same as that in Rel-15/16 NR (when SCS=15, 30, or 60 kHz, Y=one symbol, when SCS=120 kHz, Y=two symbols).

The UE capability may be reported for each frequency, may be reported for each frequency range (for example, Frequency Range 1 (FR1), Frequency Range 2 (FR2), FR2-1, FR2-2), may be reported for each cell, or may be reported for subcarrier spacing (SCS).

Note that, in a case where the minimum guard period necessary between two SRS resources in an SRS resource set for antenna switching is reported for each SCS, when an A-SRS is triggered by cross-carrier (A-SRS transmission of the second cell is triggered by DCI received in the first cell), the UE may assume that the guard period Y is calculated by SCS of a scheduling cell (the above first cell) (for example, SCS for a PDCCH in which the DCI is received).

The UE capability may be reported commonly or may be reported independently for time division duplex (TDD) and frequency division duplex (FDD).

At least one of the above-described embodiments may be applied when the UE is configured with specific information related to the above-described embodiment by higher layer signaling. For example, the specific information may be information indicating enabling control of whether to perform SRS transmission in case 1/2 or control of shift of an SRS, any RRC parameter for a specific release (for example, Rel. 17), or the like.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

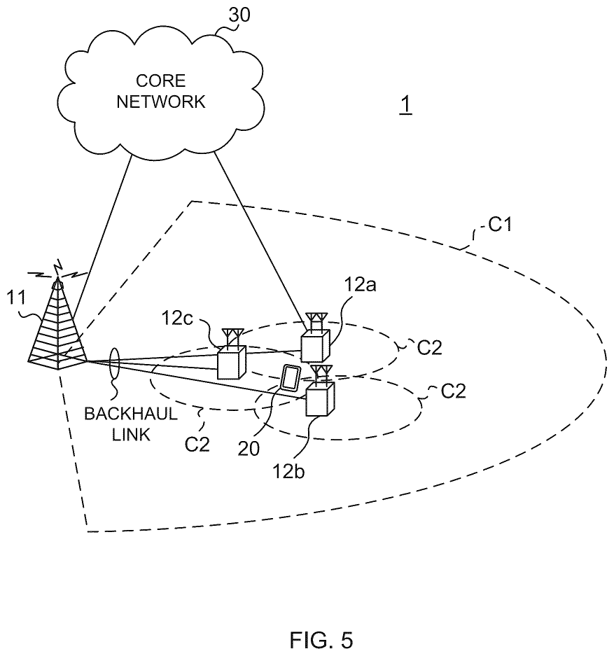

FIG. 5 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

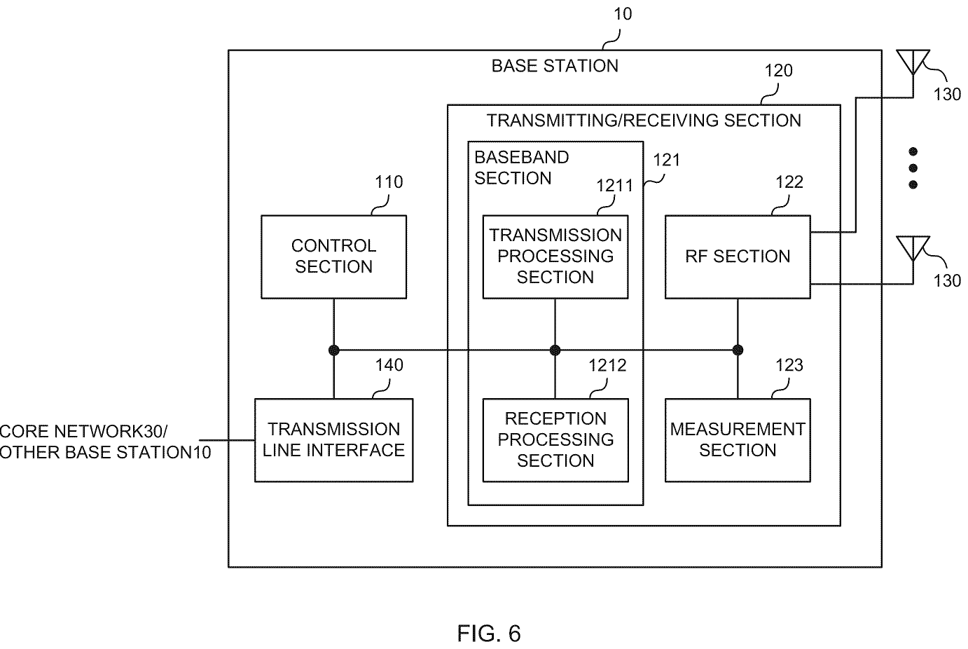

FIG. 6 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit configuration information of a reference signal for measurement (Sounding Reference Signal (SRS)) resource (for example, an RRC information element “SRS-Resource”).

The control section 110 may assume that, for transmission of an SRS of an SRS resource of at least one of a plurality of SRS resources, control of whether to perform transmission or transmission in a different SRS resource is performed in the terminal, to control SRS reception processing, when a time difference between the plurality of SRS resources is smaller than a given value.

### (User Terminal)

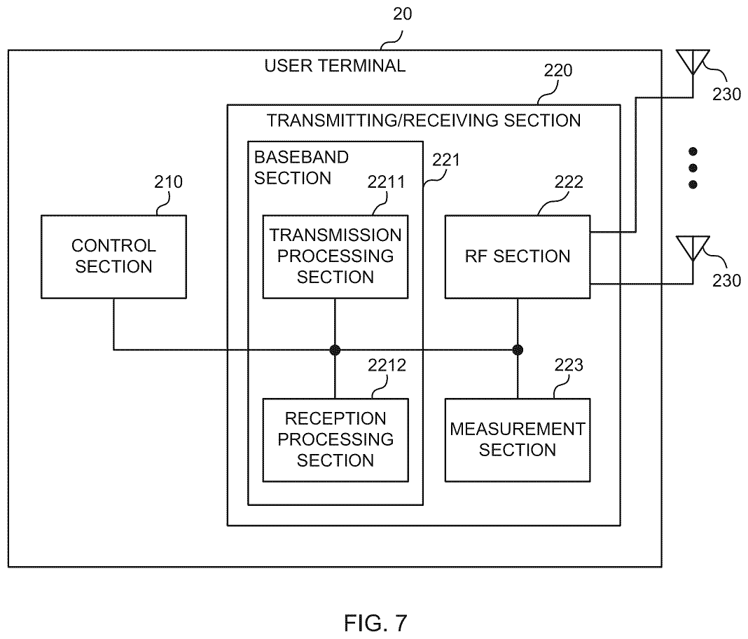

FIG. 7 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the control section 210 may perform, for transmission of a reference signal for measurement (Sounding Reference Signal (SRS)) of an SRS resource of at least one of a plurality of SRS resources, control of whether to perform transmission or transmission in a different SRS resource, when a time difference between the plurality of SRS resources is smaller than a given value.

The transmitting/receiving section 220 may transmit the SRS, based on a result of the control.

The control section 210 may perform control not to transmit the at least one SRS resource that satisfies a specific condition (condition based on any one or a combination of (1) to (9) in the first embodiment).

The control section 210 may perform control not to transmit at least one of an SRS resource same to the at least one of SRS resource at transmission timing of the at least one SRS resource or later and one or more SRS resources of an SRS resource set including the at least one SRS resource (all the time, until reconfiguration/activation is performed, or until the elapse of a given time period).

The control section 210 may determine that the different SRS resource is a resource obtained by shifting the at least one SRS resource in terms of time.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

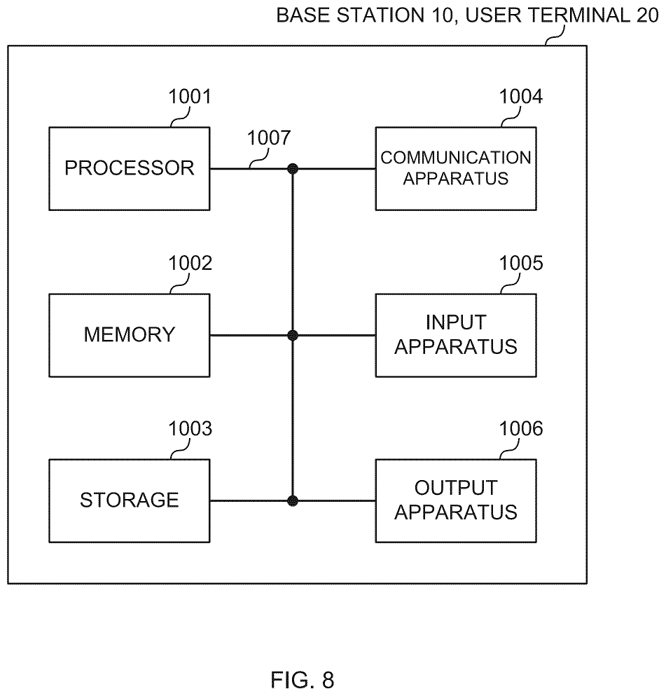

For example, a base station, a user terminal, and so on according to one embodiment of the present disclosure may function as a computer that executes the processes of the radio communication method of the present disclosure. FIG. 8 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

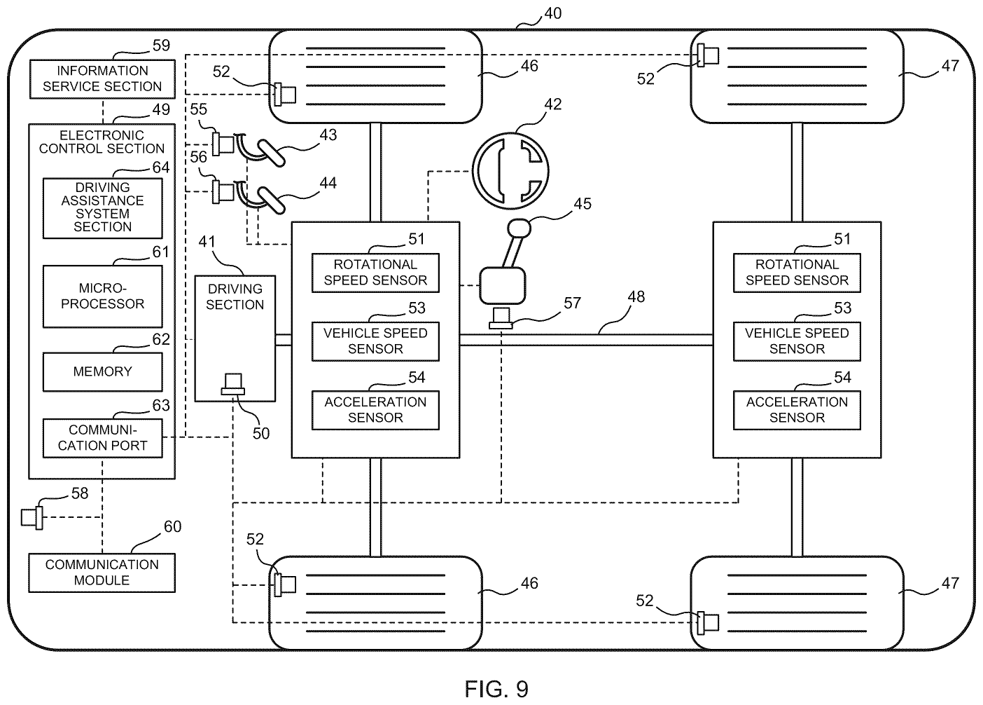

FIG. 9 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that performs, for transmission of a reference signal for measurement (Sounding Reference Signal (SRS)) of an SRS resource of at least one of a plurality of SRS resources, control of whether to perform transmission or transmission in a different SRS resource, when a time difference between the plurality of SRS resources is smaller than a given value; and
a transmitting section that transmits the SRS, based on a result of the control.

2. The terminal according to claim 1, wherein
the control section performs control not to transmit the at least one SRS resource satisfying a specific condition.

3. The terminal according to claim 1, wherein
the control section performs control not to transmit at least one of an SRS resource same to the at least one of SRS resource at transmission timing of the at least one SRS resource or later and one or more SRS resources of an SRS resource set including the at least one SRS resource.

4. The terminal according to claim 1, wherein
the control section determines that the different SRS resource is a resource obtained by shifting the at least one SRS resource in terms of time.

5. A radio communication method for a terminal, the radio communication method comprising:
performing, for transmission of a reference signal for measurement (Sounding Reference Signal (SRS)) of an SRS resource of at least one of a plurality of SRS resources, control of whether to perform transmission or transmission in a different SRS resource, when a time difference between the plurality of SRS resources is smaller than a given value; and
transmitting the SRS, based on a result of the control.

6. A base station comprising:
a transmitting section that transmits configuration information of a reference signal for measurement (Sounding Reference Signal (SRS)) resource; and
a control section that assumes that, for transmission of an SRS of an SRS resource of at least one of a plurality of SRS resources, control of whether to perform transmission or transmission in a different SRS resource is performed in the terminal, when a time difference between the plurality of SRS resources is smaller than a given value.

7. The terminal according to claim 2, wherein
the control section performs control not to transmit at least one of an SRS resource same to the at least one of SRS resource at transmission timing of the at least one SRS resource or later and one or more SRS resources of an SRS resource set including the at least one SRS resource.
